(19) United States
(12) Patent Application Publication
(10) Pub. No.: US 2026/0346766 A1
(43) Pub. Date: Nov. 5, 2026

(54) Combined Comfort and Suspension System for a Vehicle Seat

(71) Applicant: GENTHERM INCORPORATED, Novi, MI (US)

(72) Inventors: William Hardin Goodman, Fountain Inn, SC (US); Shivdeep Singh, Northville, MI (US); Timothy Normand, LaSalle (CA); David Eisenbacher, Troy, MI (US); Andrew Charles White, Greenville, SC (US)

(21) Appl. No.: 19/484,015

(22) PCT Filed: Jul. 19, 2024
(86) PCT No.: PCT/US2024/038640

§ 371 Date: Nov. 13, 2025

Related U.S. Application Data
(60) Provisional application No. 63/529,809, filed on Jul. 31, 2023.

(51) Int. Cl. B60N 2/52; B60N 2/56; B60N 2/66; B60N 2/90

(52) U.S. Cl. CPC B60N 2/525; B60N 2/56; B60N 2/665; B60N 2/976

(57) ABSTRACT

A combined comfort and suspension system for a vehicle seat that includes a suspension system; and a comfort system; the comfort system is attached to the suspension system before the combined comfort and suspension system is installed in the vehicle seat.

### CROSS-REFERENCE TO RELATED APPLICATIONS

This application claims priority to U.S. 63/529,809 filed on Jul. 31, 2023, the entirety of which is hereby incorporated by reference herein for all purposes.

### FIELD

These teachings relate to a system for a vehicle seat, and more particularly to a combined comfort and suspension system for a vehicle seat and to a method of making and installing the same.

### BACKGROUND

Some vehicle seats include one or more systems for improving occupant comfort. An exemplary comfort system may include one or more thermal systems and/or one or more pneumatic systems. A thermal system may provide heating and/or cooling functions to an occupant of the vehicle seat. A pneumatic system may provide massage and/or lumbar functions to an occupant of the vehicle seat. While consumers enjoy such comfort systems, the systems may undesirably complicate vehicle seat design; may require multiple systems to be supplied to a vehicle seat manufacturer from multiple vendors; and/or may complicate vehicle seat assembly. Moreover, during installation of these individual comfort systems in a vehicle seat, the thermal system and/or the pneumatic system may inadvertently move independently of one another, which may cause one or more features of the comfort system to detach or move, which may undesirably reduce or degrade performance of the comfort system(s). It may therefore be desirable to improve the current state of the art.

For example, it may be advantageous to reduce the number of separate or individual comfort systems in a vehicle seat, without reducing the number of comfort amenities available in the vehicle seat. It may be desirable to combine certain individual systems to reduce the number of separate systems that must be handled and installed in a vehicle seat. It may be desirable to combine certain individual systems in a vehicle seat to reduce the number of separate or individual systems that must be handled and installed in a vehicle seat which may reduce or prevent improper installation. For example, it may be desirable to combine a suspension system of a vehicle seat with one or more comfort systems, which may include one or more thermal and/or pneumatic systems.

### SUMMARY

These teachings provide a comfort and suspension system for a vehicle seat. The comfort system according to these teachings may include a thermal system, a pneumatic system, a seat cushion, or a combination thereof. By combining the seat suspension system with one or more comfort systems, the number of separate systems that must be handled and/or installed at a vehicle seat assembly location may be reduced, which may advantageously reduce assembly time, complexity, costs and/or improper installation.

### BRIEF DESCRIPTION OF THE DRAWINGS

FIG. 1 is a side view of a vehicle that includes a vehicle seat.

FIG. 2A is a perspective view of a vehicle seat that includes one or more combined seat systems.

FIG. 2B is a perspective view of a vehicle seat that includes one or more combined seat systems.

FIG. 3A is a perspective view of a comfort system that is a thermal system.

FIG. 3B is a side view of a comfort system that is a thermal system.

FIG. 4 is a side view of a combined seat system that includes a comfort system and a suspension system.

FIG. 5 is a side view of a combined seat system that includes a comfort system and a suspension system.

FIG. 6 is a side view of a combined seat system that includes a comfort system and a suspension system.

FIG. 7 is a side view of a combined seat system that includes a comfort system and a suspension system.

FIG. 8 is a side view of a combined seat system that includes a comfort system and a suspension system.

FIG. 9 is a side view of a combined seat system that includes a comfort system and a suspension system.

FIG. 10A is a front view of a comfort system that is a pneumatic system.

FIG. 10B is a side view of a comfort system that is a pneumatic system.

FIG. 11 is a side view of a combined seat system that includes a comfort system and a suspension system.

FIG. 12 is a side view of a combined seat system that includes a comfort system and a suspension system.

FIG. 13 is a side view of a combined seat system that includes a comfort system and a suspension system.

FIG. 14 is a side view of a combined seat system that includes a comfort system and a suspension system.

FIG. 15 is a side view of a combined seat system that includes a comfort system and a suspension system.

FIG. 16 is a side view of a combined seat system that includes a comfort system and a suspension system.

FIG. 17 is a side view of a combined seat system that includes a comfort system and a suspension system.

FIG. 18 is a side view of a combined seat system that includes a comfort system and a suspension system.

FIG. 19 is a side view of a combined seat system that includes a comfort system and a suspension system.

FIG. 20 is a side view of a combined seat system that includes a comfort system and a suspension system.

### DETAILED DESCRIPTION

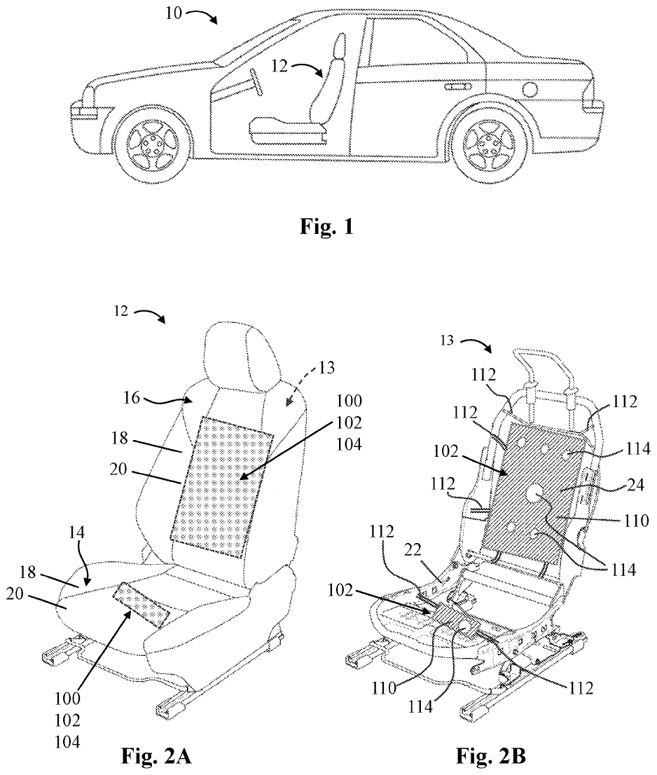

FIG. 1 illustrates a vehicle 10. The vehicle 10 comprises one or more vehicle seats 12.

FIG. 2A illustrates a vehicle seat 12. The vehicle seat 12 comprises a frame 13 (FIG. 2B). The frame 13 may support a seating portion 14 and/or a backrest portion 16 of the vehicle seat 12. The seating portion 14 and the backrest portion 16 may include a cushion 18. The cushion 18 may be a single cushion for both portions 14, 16. The cushion 18 may be separate structure for each portion 14 or 16. A cover or trim layer 20 may be disposed over and cover the cushion 18 and other components of the vehicle seat 12. The cover or trim layer 20 may be perforated leather, cloth, etc. A user or occupant of the vehicle seat 12 may be in contact with an A-side or surface of the cover or trim layer 20 when seated in the seat 12 or in the vehicle.

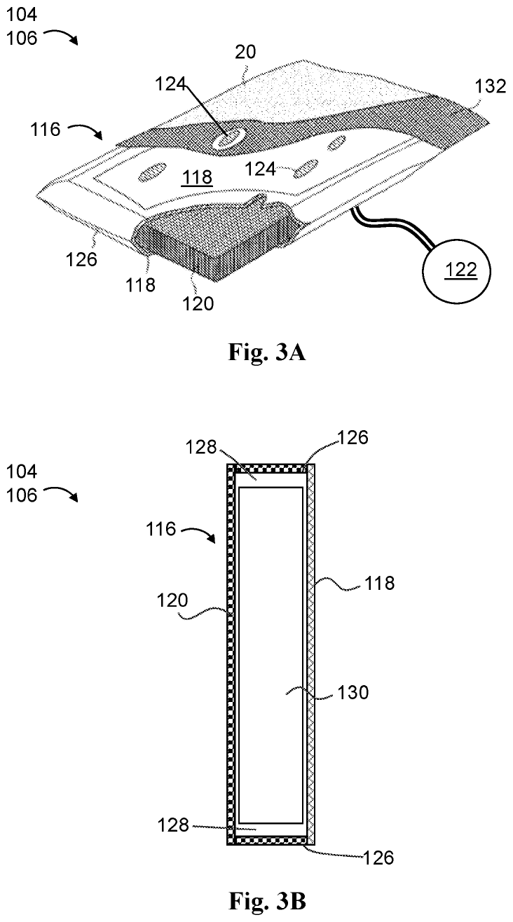

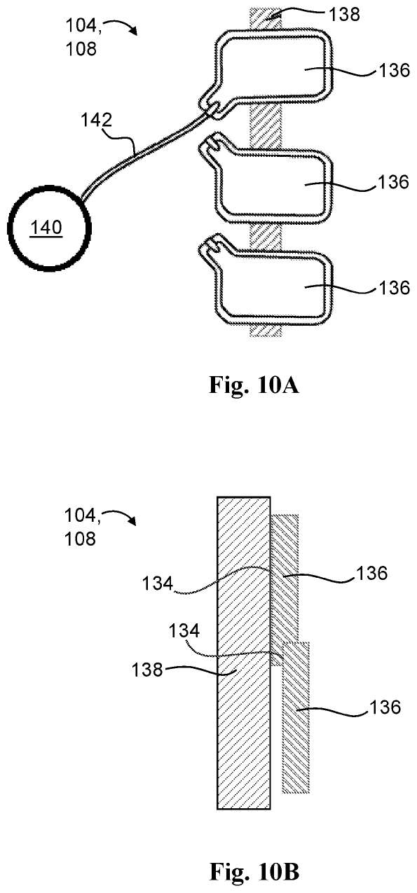

The vehicle seat 12, the seating portion 14, and/or the backrest portion 16 may include one or more combined comfort and suspension systems 100. A combined comfort and suspension system 100 (which may be referred to herein as a system, or combined system, or assembly) may include a seat suspension system 102 (FIG. 2B) and one or more comfort systems 104. In some configurations, the combined comfort and suspension system 100 may also include a seat cushion 18. A comfort system 104 may include one or more thermal systems 106 (FIG. 3A/B) and/or one or more pneumatic systems 108 (FIG. 10A/B) and/or seat cushions 18.

Referring to both FIGS. 2A and 2B, the seat frame 13 may include a seating portion frame 22 that corresponds to the seating portion 14 of the seat 12 (FIG. 2A). The seat suspension system 102 may include a suspension mat 110 that is attached to the frame 13 or the seating portion frame 22 via one or more suspension attaching members 112. The suspension 102 may function as the base to support one or more of the components of the seat 12 discussed herein, such as the cushion 18, the seat system 100, the one or more comfort systems 104, or a combination thereof and the occupant. The suspension mat 110 may include one or more orifices or pass-through features 114.

The seat frame 13 may comprise a backrest portion frame 24 that corresponds to the backrest portion 16 of the vehicle seat 12 (FIG. 2A). The frame 13 may include another suspension 102 independent of the suspension at the seating portion frame 22. Alternatively, the frame 13 may include a single suspension 102 for both frame portions 22, 24. The statements relating to the suspension mat 110 at the seating portion frame 22 apply to the suspension mat 110 at the backrest portion frame 24 and vice versa.

FIGS. 3A and 3B illustrate a comfort system 104. The comfort system 104 may be a thermal system 106. The thermal system 106 may be of the type disclosed in U.S. Pat. No. 6,869,140 B2 and/or US20070176471 A1, the entireties of which are hereby incorporated by reference herein for all purposes.

The thermal system 106 may include a bag structure 116. The bag structure 116 may be formed or defined by or between a top layer 118 and an opposing bottom layer 120. The bottom layer 120 may include one or more openings through which one or more blowers or air movers 122 may push or direct air or an air flow into and/or out of the bag structure 116. The blower or air mover 122 may be directly connected to the bottom layer 120 or may be connected thereto via one or more tubes, channels, ducts, etc. The top layer 118 may include one or more ventilation apertures 124 through which the air flow can be pushed or blown into the bag structure 116 or can be exhausted or distributed. In some configurations, air may be pulled or drawn into the bag structure 116 through one or more ventilation apertures 124 and then exhausted from the bag structure 116 through one or more other apertures 124 in the top and/or bottom layers 118, 120.

The top and bottom layers 118, 120 may be connected at their edges 126 to form a pocket, pouch or open space 128 therebetween. The edges 126 may be at a location generally centered between the two layers 118, 120 (FIG. 3A), or the edges 126 may be closer to the top layer 118 (FIG. 3B), or closer to the bottom layer 120 (not illustrated).

A spacer layer 130 may be arranged or situated within the pocket, pouch, or open space 128 of the bag structure 116 (e.g. between the top and bottom layers 118, 120). The spacer layer 130 may function to prevent collapsing of the bag structure 116. That is, the spacer layer 130 may resist collapsing of the bag structure 116 and prevent the layers 118 and 120 from contacting one another after a load or occupant is present in the vehicle seat. A heating layer 132 may be provided on or over the bag structure 116, above the top layer 118, and below the cover or trim layer 20 of the vehicle seat (FIG. 3A). In some configurations, the heating layer 132 may be located within the bag structure 116. In some configurations, the heating layer 132 may also be the top layer 118 of the bag structure 116 (i.e., the heating layer 132 may be the actual top layer 118 and vice versa). In some configurations, the heating layer 132 may be omitted. In a heating layer 132 omitted configuration, the trim or cover layer 20 may be located over the top layer 118. In a heating layer 132 omitted configuration, the trim or cover layer 20 may be the actual top layer 118 of the bag structure and vice versa.

The thermal system 106 and/or the heating layer 132 may be configured to generate heat during or after power is supplied to the heating layer 132 from a power source. In some configurations, the air mover may push air through the bag structure 116 and/or heating layer 132 to direct the warmth generated by the heating layer 132 towards the occupant. In some configurations, the thermal system 106 may be configured to cool an occupant in the vehicle seat 12 by passing or distributing an air flow through the trim layer 20 of the vehicle seat towards the occupant without the heating layer 118 being activated (i.e., not generating heat). In some configurations, the air mover 122 may draw air into the bag structure 116 and away from the occupant in the vehicle seat 12.

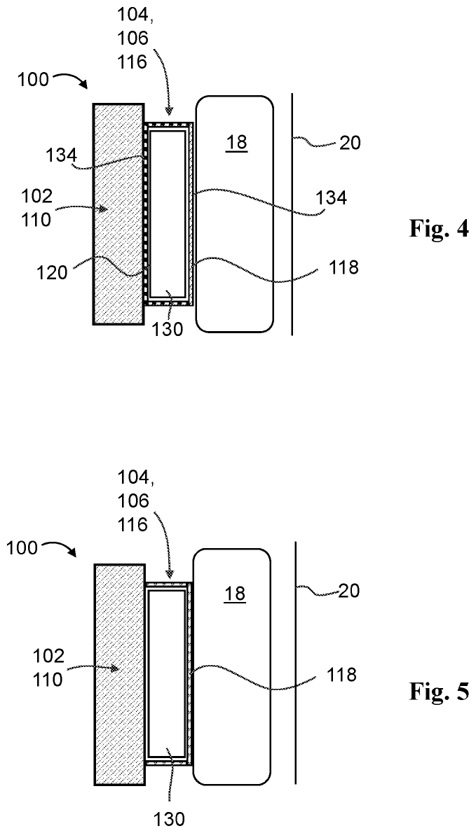

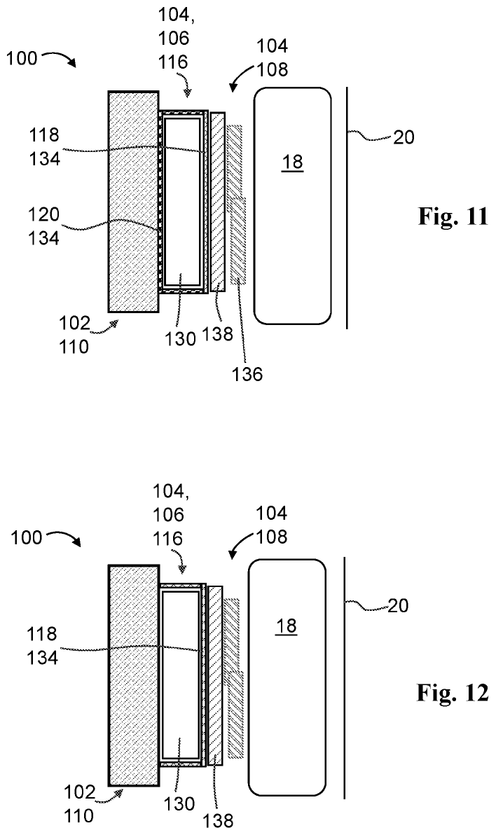

FIGS. 4-20 illustrate various combined comfort and suspension systems 100 according to these teachings. Unless otherwise described and/or illustrated, the structure and/or function of the seat systems 100 may apply to all examples. In other words, unless otherwise noted, the description of FIG. 4 may apply to FIG. 5, FIG. 11, FIG. 12, etc., and vice versa. Moreover, it is understood that unless otherwise noted the structure of one or more of the illustrated examples may be combined. For example, a non-limiting example of this is that the pneumatic system illustrated in FIGS. 10A-10B may be incorporated into one or more of the systems 100 in FIGS. 4-9. It is also understood that modifications to the systems 100 are envisioned that are not necessarily illustrated and/or described. For example, a non-limiting example of this is that the pneumatic system 108 in FIGS. 11 and/or 12 may be moved to the inside of the bag structure and connected to the A-side of the mat 110 or to the bottom layer 120 via one or more connection methods disclosed herein. Accordingly, any structure of the comfort system, pneumatic system, and suspension system illustrated and/or described herein may be combined with other structure (illustrated or not) to create a vehicle seat 12 and/or seat system 100.

FIG. 4 illustrates a combined comfort and suspension system 100. The seat system 100 may be a combined system that comprises a suspension system 102 and a comfort system 104. The comfort system 104 may be a thermal system 106. The suspension system 102 may be joined or connected to the comfort system 104 either temporarily or permanently via one or more connectors or connecting methods 134. In other words, the suspension mat 110 may be connected to the bottom layer 120 of the bag structure 116 via one or more connectors or connecting methods 134 thereby providing a single or integrated system 100. Temporarily connected means the two systems 102, 104 may be joined or connected and then subsequently detached or separated without damaging either or both of the systems. Permanently connected means that after the two systems 102, 104 are joined or connected, they cannot be separated or detached from one another and/or from the seat without damaging either or both of the systems and/or the seat. The comfort system 104 may be anterior to the suspension mat 110 (i.e., on an A-surface of the mat 110).

The comfort system 104 or the top layer 118 may be located below the cushion 18 and optionally joined or connected to the cushion 18 via one or more connectors or connecting methods 134. A trim or cover 20 may be disposed at least partially over and/or around the cushion 18, comfort system 104, suspension system 102, or a combination thereof.

FIG. 5 illustrates a combined comfort and suspension system 100 that may be substantially like the seat system 100 of FIG. 4. Therefore, only the differences between the systems 100 will be described. In the system 100 of FIG. 5, the bottom layer or panel 120 of the thermal system 106 may be omitted. Instead, the top layer 118 and/or the spacer layer may be directly or indirectly connected to the mat 110 via one or more connectors or connection methods 134. Therefore, the suspension mat 110 may also function as the bottom layer 120 of the bag structure 116 to create the bag structure and the open space is defined between the suspension mat 110 and the top layer 18 and the spacer layer is optionally therebetween.

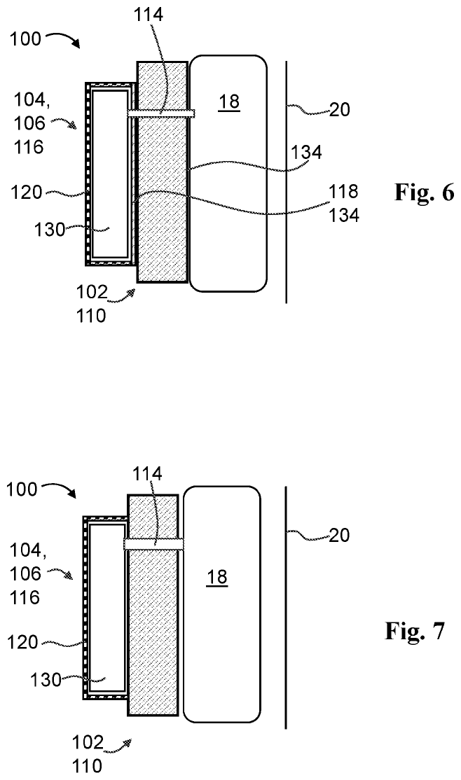

FIG. 6 illustrates a combined comfort and suspension system 100. The seat system 100 of FIG. 6 may be substantially similar to the other seat systems illustrated and described herein. The seat system 100 may be a combined system that comprises the suspension system 102 and the comfort system 104. The comfort system 104 may be the thermal system 106. The thermal system 106 may be connected posterior to the suspension system 102 or mat 110. The suspension system 102 or suspension mat 110 may be joined or connected to the comfort system 104 or to the top layer 118 via one or more connectors or connecting methods 134 to create the integrated seat system 100. One or more orifices or pass through features 114 may extend through a thickness of the suspension mat 110. In other configurations, one or more of the orifice or pass through features 114 may additionally or may instead pass around the suspension mat 110 and not through a thickness of the mat 110. The one or more of the orifice or pass through features 114 may allow for an air flow to pass between the comfort system 104 or bag structure 116 and the cushion 18 or occupant in contact with the cushion 18. The one or more orifice or pass through features may be one or more tubes, pipes, conduits, or bores in the aforementioned features or elements.

FIG. 7 illustrates a combined comfort and suspension system 100 that may be substantially like the seat system 100 of FIG. 6. Therefore, only the differences between the systems 100 will be described. In the system 100 of FIG. 7, the top layer or panel 118 of the thermal system 106 may be omitted. Instead, the bottom layer 120 and/or the spacer layer 130 may be directly or indirectly connected to the mat 110 via one or more connectors or connection methods 134. Therefore, the suspension mat 110 may function as the top layer of the bag structure and the open space is defined between the suspension mat 110 and the bottom layer 120.

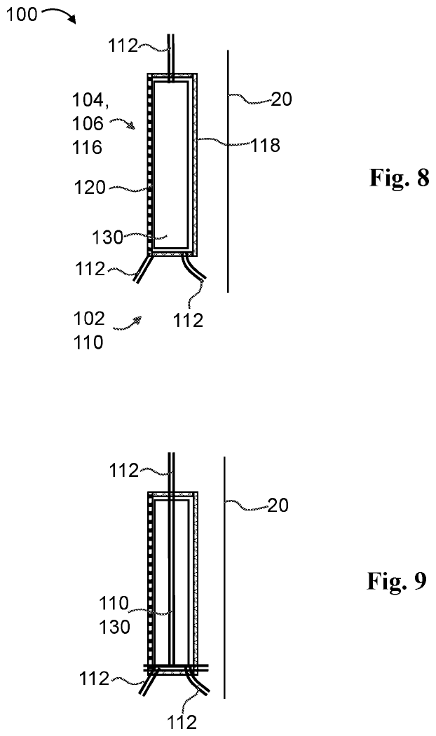

FIGS. 8 and 9 illustrate a combined comfort and suspension system 100. The seat system 100 comprises a suspension system 102 and a comfort system 104. The comfort system 104 may be a thermal system 106. In FIG. 8, the comfort system 104 may also function as the suspension mat 110 and vice versa. The comfort system 104 may be connected or supported at the frame 13 via the one or more suspension attaching members 112. The one or more suspension attaching members 112 may be connected or attached to the top layer 118, the bottom layer 120, the spacer layer 130, or a combination thereof. In FIG. 9, the spacer layer 130 may be the suspension mat 110 and vice versa. In other words, the mat 110 may be located inside of the bag structure 116 and may function as the spacer layer 130 and vice versa. A cushion (not illustrated) may be located between the top layer 118 and the cover or trim layer 20. The one or more suspension attaching members may be one or more springs, wires, cables, ties, fabrics, fasteners, connectors or connecting methods disclsoed herein, or any combination thereof suitable for securing the comfort system 103 to the frame 13.

FIGS. 10A and 10B illustrate a comfort system 104. The comfort system 104 may be a pneumatic system 108. The pneumatic system 108 may be of the type disclosed in U.S. Pat. No. 10,906,442 B2, the entirety of which is hereby incorporated by reference herein for all purposes. The pneumatic system 108 may be a massage system, a lumbar system, or both.

The pneumatic system 108 may include one or more air cells, bladders, balloons, bags, and/or bubbles 136 that are connected or supported to one another and/or to a carrier or substrate 138 via one or more connectors or connection methods 134. The air cells or bladders 136 may be connected to one or more fluid sources 140 via one or more tubes 142. The fluid source 140 may be configured to supply a fluid such as air through the one or more tubes 142 to inflate the one or more air cells or bladders 136. The air cells or bladders 136 may be deflated by removing or purging the fluid therefrom. The fluid may be air or a liquid or both.

FIG. 11 illustrates a combined comfort and suspension system 100. The seat system 100 may be a combined system that comprises a suspension system 102 and a comfort system 104. The comfort system 104 may be a thermal system 106 and a pneumatic system 108. The suspension system 102 or suspension mat 110 may be joined or connected to the comfort system 104 or to the bottom layer 120 of the thermal system 106 via one or more connectors or connecting methods 134. The carrier or substrate 138 of the pneumatic system 108 may be connected or joined to the top layer 118 of the thermal system 106 via one or more connectors or connecting methods 134. The cushion 18 may be provided over or on top of the pneumatic system 108. A trim or cover 20 may be disposed at least partially over and/or around the cushion 18, comfort system 104, suspension system 102, or a combination thereof.

FIG. 12 may be substantially like the combined comfort and suspension system 100 of FIG. 11, except that the bottom layer 120 of the thermal system 106 may be omitted. Instead, the top layer 118 and/or the spacer layer 130 may be connected to the suspension mat 110 of the suspension system 102 via one or more connectors or connection methods 134. Therefore, the suspension mat 110 may function as the bottom layer 120 of the bag structure 116 and vice versa and the open space is between the mat 110 and the top layer 118.

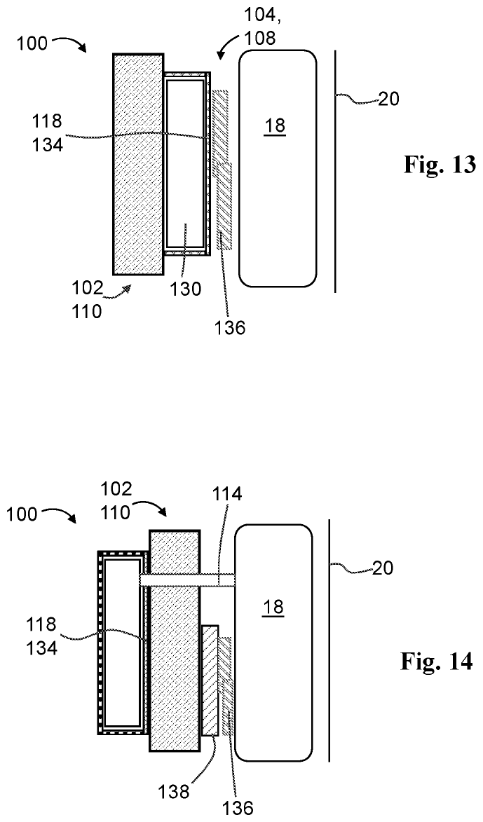

FIG. 13 may be substantially like the combined comfort and suspension system 100 of FIG. 11, except that the carrier or substrate 138 supporting the one or more air cells 136 may be omitted. Instead, the one or more air cells 136 may be connected to the top layer 118 of the of the thermal system 106 or the top layer of the bag structure 116 via one or more connectors or connection methods 134. Therefore, the top layer 118 of the thermal system 106 may function as the carrier or substrate of the pneumatic system 108.

FIG. 14 illustrates a combined comfort and suspension system 100. The seat system 100 may be a combined system that comprises a suspension system 102 and a comfort system 104. The comfort system 104 may be a thermal system 106 and a pneumatic system 108. The suspension system 102 or suspension mat 110 may be joined or connected to the comfort system 104 or to the top layer 118 via one or more connectors or connecting methods 134. The comfort system 104 may include one or more orifices or pass through features 114 that extend through a thickness of the suspension mat 110. In other configurations, one or more of the orifice or pass through features 114 may additionally or may instead pass around the suspension mat 110 and not through a thickness of the mat 110. The one or more of the orifice or pass through features 114 may allow for an air flow to pass between the comfort system 104 or bag structure 116 and the cushion 18 or occupant in contact with the cushion 18. The one or more orifice or pass through features may be one or more pipes, tubes, conduits, openings, etc.

The pneumatic system 108 may be arranged between the suspension mat 110 and the cushion 20. In the configuration illustrated in FIG. 14, the carrier or substrate 138 supporting the one or more air cells 136 may be connected to the top layer 118 of the thermal system 106 or to the top layer of the bag structure 116 via one or more connectors or connecting methods 134.

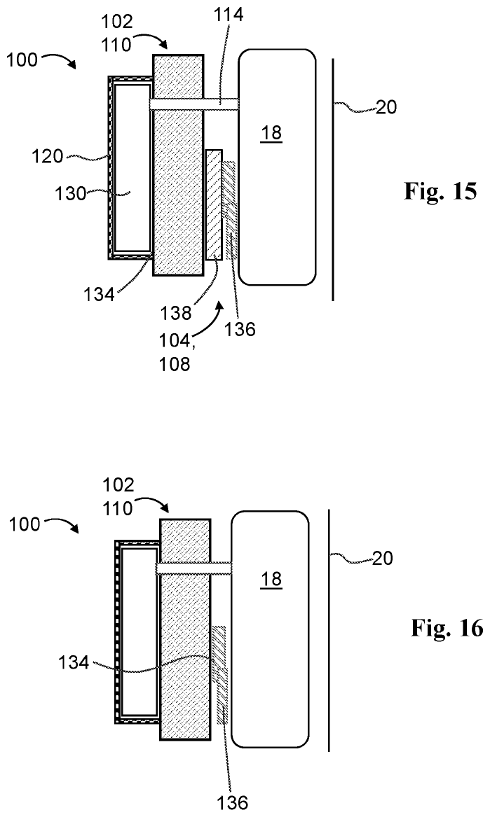

FIG. 15 illustrates a combined comfort and suspension system 100 that may be substantially like the system 100 illustrated and described in FIG. 14. However, in the configuration of FIG. 15, the top layer 118 of the thermal system 106 is omitted. Instead, bottom layer 120 and/or the spacer layer 130 may be connected to the suspension mat 110 of the suspension system 102 via one or more connectors or connection methods 134. Therefore, the suspension mat 110 may function as the top layer 118 of the bag structure 116 and the open space is defined therebetween.

FIG. 16 illustrates a combined comfort and suspension system 100 that may be substantially like the system 100 illustrated and described in FIG. 15. However, in the configuration illustrated in FIG. 16, the carrier or substrate 138 of the pneumatic system 108 may be omitted, and the one or more air cells 136 may be connected to the suspension mat 110 via one or more connectors or connection methods 134. Therefore, in such a configuration, the suspension mat 110 may function as the carrier or substrate of the pneumatic system 108.

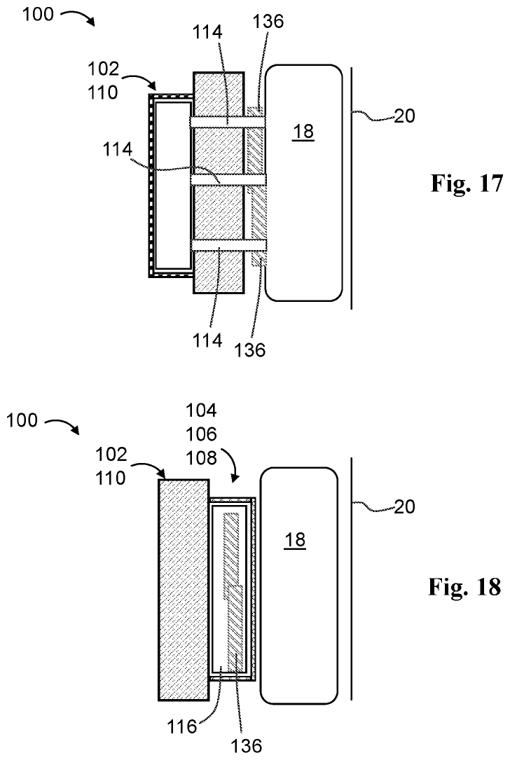

FIG. 17 illustrates a combined comfort and suspension system 100 that may be substantially like the system 100 illustrated and described at FIG. 16. However, in the configuration illustrated in FIG. 17, the thermal system 102 includes more than one orifice or pass through feature 114 extending through the suspension mat 110. Also, one or more of the pass-through features 114 may extend through or around one or more of the air cells 136 of the pneumatic system 108.

FIG. 18 illustrates a combined comfort and suspension system 100. The seat system 100 may be a combined system that comprises a suspension system 102 and a comfort system 104. The comfort system 104 may be a thermal system 106 and a pneumatic system 108. The one or more air cells 136 are located within the open space of the bag structure and may be connected or attached to an inside surface of the top layer of the bag structure, the bottom layer of the bag structure, to the mat 110 (if the bottom layer of the bag structure is omitted), to a spacer layer located within the open space, to an inside or B-side of the cushion 18 if the top layer of the bag structure is eliminated, or any combination thereof. In some configurations, the one or more air cells 136 may be located within the open space within being securely attached to any structure or surface thereof (i.e., the one or more air cells 136 may be snugly fit and held in place between the two structural surfaces or layers defining the open space.

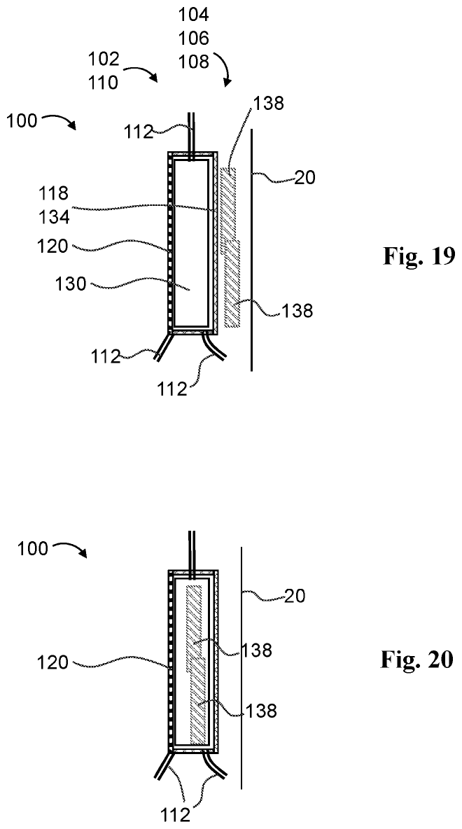

FIGS. 19 and 20 illustrate a combined comfort and suspension system 100. The seat system 100 may comprise a suspension system 102 and a comfort system 104. The comfort system 104 may be a thermal system 106 and pneumatic system 108. The comfort system 104 may also function as the suspension mat 110 and vice versa. The comfort system 104 may be connected or supported at the frame 13 via the one or more suspension attaching members 112. The one or more suspension attaching members 112 may be connected or attached to the top layer 118, the bottom layer 120, the spacer layer 130, or a combination thereof. The one or more air cells 138 may be connected or attached to the top layer 118 of the bag structure 116 via one or more connectors or connection methods 134. However, in some configurations, the carrier 136 may be included and connected to the top layer 118 of the bag structure 116. In other configurations, the top layer 118 may be omitted and the carrier 138 of the pneumatic system 104 may be connected to the spacer layer and/or the bottom layer 120 of the thermal system 106. In such a configuration, the carrier 136 may function as the top layer 118 of the bag structure 116. A cushion (not illustrated) may be located between the top layer 118 and the cover or trim layer 20. In FIG. 20, the pneumatic system 108 arranged inside of the bag structure 116 of the thermal system 106. The thermal system 106 may or may not include the spacer layer 130 within the bag structure 116. The pneumatic system 108 may or may not include the carrier 138 that supports the one or more air cells 136. In this regard, the one carrier 138 (if present) or the air cells 138 may be attached to the bottom layer 120 of the thermal system 106.

The following description applies to all examples disclosed herein, unless otherwise noted.

These teachings provide a system that includes a comfort system and a suspension system. The system, the combined system, or the combined comfort and suspension system, may also be referred to as a seat system, a system, a combined seat system, a combined system, an integrated comfort and suspension system etc. The seat system may include one or more systems. Preferably, the seat system includes two or more systems. The seat system may include one or more comfort systems, one or more suspension systems, one or more thermal systems, one or more pneumatic systems, one or more lumbar systems, one or more massage systems, one or more cushions, or a combination thereof. The seat system may be assembled at a single manufacturing or assembly location and then shipped to an assembly facility as a single, connected or integrated unit. It is also envisioned however, that the individual systems of the combined seat system may be assembled or connected at the seat assembly facility before installation into the vehicle seat. However, it is also considered that the seat system may be assembled or connected upon or after installation into the vehicle seat.

Advantageously, the seat system according to these teachings may combine two or more systems so that an operator or assembly machine or procedure may require less steps or time to assemble the vehicle seat. Advantageously, the seat system according to these teachings may combine two or more systems which may reduce transportation costs to the assembly facility, reduce the storage footprint and number of individual part numbers at the assembly location, etc. Further advantages of the system according to these teachings will be readily apparent to those skilled in the art.

The vehicle seat may include one or more suspension systems. The combined system according to these teachings may include one or more suspension systems. A suspension system may function to support an object or occupant in a vehicle seat. The suspension system may provide a base or support structure for the other structure of the vehicle seat (i.e., the cushion, comfort system, thermal system, occupant sensors, etc.) A suspension system may function to provide a cushioning or dampening effect to stabilize an occupant or object in the vehicle seat.

The suspension system may comprise one or more suspension mats (or mat). The suspension mat may function as the base of the seat or suspension structure. The suspension mat may be a plate structure and/or wireframe made of a suitable material such as a metal, polymer, composite, or some combination thereof. The suspension mat may be a fabric, sheet, net, or textile. The properties of the suspension system (i.e., mat and/or suspension attaching members), such as wire thickness, wire stiffness, material hardness, material stiffness, material resilience, shock absorption, damping properties, etc. can be modified (i.e., increased or decreased) to affect the seat feel and occupant comfort. The suspension system may include one or more wires, springs, coils, damping materials, or a combination thereof. The suspension mat can be covered in full or partially by a substrate, such as felt or cushion to aid in its function. The suspension mat may include one or more cut-outs, pass-throughs, mounting holes, and other such features that may function to allow elements of the seat to be routed, assembled, and otherwise attached to the suspension structure or other seat elements, such as cables, tubes, sensors, electronics, wires, air flow, fasteners, etc.

The vehicle seat may include one or more comfort systems. The combined system according to these teachings may include one or more comfort systems. A comfort system may be an insert or assembly that comprises one or more or two or more comfort producing functions. The comfort system may be a combination of two or more systems that are typically installed as individual components in a vehicle seat. For example, the comfort system may comprise a pneumatic system (massage and/or lumber system) and a thermal system such as a heating system and/or a cooling system, Advantageously, the comfort system according to these teachings may be attached or combined with the suspension system and then installed in a vehicle seat in one installation process as opposed to two or more individual steps or processes as is known in the art.

The comfort system according to these teachings may be assembled or connected or to the suspension system off site or off-line from the vehicle seat assembly location. Alternatively, the comfort system may be assembled or connected according to these teachings online before the comfort system is attached or installed in the vehicle seat. In some configurations, the attachment of the two systems or components of the system may take place before the comfort system is installed in the vehicle seat. Alternatively, the attachment of the two systems or components of the system may take place while the comfort system is installed in the vehicle seat or after the comfort system is installed in the vehicle seat.

The comfort system or the thermal system may comprise one or more bag or hollow structures. A bag structure may be comprised of one or more top and bottom layer or sheets that are joined or fastened together via one or more fasteners or connectors or connection methods disclosed herein to form a hollow pillow-cover like device. The top and bottom layers may be air permeable or air impermeable. The top sheet may include one or more ventilation apertures through which air blown or pushed in the bag structure can be expelled. In some configurations, the one or more ventilation apertures can be used for drawing air into the bag structure. The bottom sheet may include one or more apertures through which air may be blown or pushed into the bag structure from one or more blowers or air movers. In some configurations, the one or more apertures in the bottom sheet can be used for expelling air from the bag structure.

The comfort system according to these teachings makes use of one or more spacer layers. A spacer layer may function to reduce read through or visibility of one or more elements or components of the comfort system through an A-surface of the vehicle seat. The spacer layer may function to provide additional padding and or support to an occupant in the vehicle seat. The spacer layer may be sufficiently thick to provide padding and additional comfort to the occupant and reduce read through of any of the comfort functions through an A side of the vehicle seat, however, to not interfere with any massage or lumbar functions of the pneumatic system. The spacer layer may function to change modify the feel of the seat, increase, or decrease an intensity of the massage or lumbar functions of the pneumatic system that is seen and/or felt by an occupant, or both. The spacer layer may be an air permeable material or layer. The spacer layer may function to facilitate an even distribution of air flow. The spacer layer may be an air impermeable material or layer. The spacer layer may be made of a cloth, fleece, and/or felt material, spun bond material, polyester material, a PET material (polyethylene terephthalate), a foam, a plush foam, or a combination thereof. The spacer layer may be felt or similar, or spacer fabric such as that supplied by Mueller Textile of Germany.

The spacer layer may be configured to generally retain its three-dimensional shape when subjected to compressive and/or other types of forces. The spacer layer may include internal pores or passages that permit air or other fluid to pass therethrough. For example, the spacer layer can comprise an internal lattice or other structure which has internal openings. The spacer layer may be a screen or a mesh. The spacer layer may be compressible, elastic, resilient, or a combination thereof. The spacer layer may be breathable, resistant to crushing, and/or made from a foam, plastic, and/or polymeric material. The spacer layer may have sufficient resiliency to prevent crushing of spacer layer when an occupant sits on or leans back against the vehicle seat. The spacer layer may include an upper netting layer, a lower netting layer and a plurality of fibers extending between them. The spacer layer may be a heating layer. The heating layer may be configured to generate heat or warmth in response to a supply of electrical energy.

The comfort system may include one or more pneumatic systems. The pneumatic system may be configured to provide lumbar and/or massage functions to an occupant of a vehicle seat. The pneumatic system may be of the type disclosed in U.S. Patent Publication No. US2012/0313420, US21013/0127226, and/or U.S. Pat. No. 10,906,442 B2 all of which is expressly incorporated by reference herein for all purposes. The pneumatic system may include one or more air cells or bladders. The one or more air cells or bladders may be connected to one or more fluid sources via one or more tubes or conduits. The fluid source may be configured to supply a fluid through the one or more tubes to inflate the one or more air cells or bladders to provide the lumbar and/or massage functions. The air cells or bladders may be deflated by removing or purging the fluid therefrom. The air cells or bladders may be connected or supported on a carrier. The air cells or bladders may be connected or supported on or more features or structures of the combined system, including but not limited to one or more layers of the bag structure (inside and/or outside), the suspension mat, the heating layer, the trim layer (back or bottom side), or a combination thereof.

The thermal system may be configured to provide heating, cooling, or ambient functions. The thermal system may be of the type disclosed in U.S. Pat. No. 6,869,140 B2, the entirety of which is hereby incorporated by reference herein for all purposes.

The thermal system may be of the type and/or may include teachings that are at least partially, or entirely, disclosed in any of the following U.S. Pat. Nos. 11,033,058; 7,560,670; 7,285,748; 7,223,948; 6,838,647; 6,710,303; 6,150,642; 5,451,747; 4,931,627; 4,777,351; U.S. Patent Publication Nos. 20200406797, 20200025424 and/or 2010/0289303, all of which are expressly incorporated herein by reference for all purposes. The thermal system may be a cooling mat that may include one or more cooling elements. The one or more cooling elements may be one or more graphite/graphene strips, as disclosed in U.S. Pat. No. 11,033,058 and US Publication US20200025424A1, both of which are incorporated by reference for all purposes. The thermal system may be a heating mat that may include one or more heating elements. The one or more heating elements may be one or more wires or conductors that are arranged on, below, and/or are integrated into the substrate. The shape of the one or more heating elements may be provided in a myriad of configurations, which may also depend on one or more factors like the vehicle seat design. For example, the one or more heating elements may be a resistive wire that winds, meanders, zigzags, etc. on the substrate. The one or more heating elements may be configured to be supplied with power from a power source and then generate heat in response to the power supply. The heat may warm the surface of the vehicle seat and thus provide warmth to an occupant.

The comfort system may be of the type disclosed in U.S. 63/432,779 filed on Dec. 15, 2022 and/or U.S. 63/462,585 and/or 63/462,574 both of which were filed on Apr. 28, 2023, the entirety of which is hereby incorporated by reference herein for all purposes.

Reference is made herein to using one or more connectors or connection methods herein. The one or more connectors or connection methods may be used for attaching or connecting the one or more air bladders or cells to the carrier of the pneumatic system; for attaching or connecting the carrier of the pneumatic system to one or more layers of the bag structure; for connecting one or more layers of the bag structure to one another; for connecting the spacer layer the one or more carriers and/or layers of the bag structure; for connecting or attaching the comfort system to the vehicle seat or seat foam; for connecting or attaching the comfort system (thermal system and/or pneumatic system) to the suspension system or suspension mat; for connecting or attaching the combined seat system to a seat frame; for connecting or attaching any of the structure disclosed herein to each other or to a vehicle seat; or any combination thereof.

The one or more connectors or connection methods may be or may include one or more components and/or methods that include: lamination, tape, double-sided adhesive tape, single sided adhesive tape, pressure sensitive adhesive, glues, epoxies, hog rings, stitching, sewing, welding, high-frequency welding, IR welding, RF welding, ultrasonic welding, sealing, heat sealing, heat staking, chemical fixation or bonding, hook and loop fasteners, staples, rivets, pins, buttons, snaps, bands, straps, heating, melting, etc., or a combination thereof.

In some configurations, a connector or connection method may refer to the method of weaving or inserting a portion of a layer or carrier through a slit, slot, or aperture in the suspension mat or other layer or carrier. A system may be secured to the suspension mat by pulling or weaving an end of the layer or carrier through the aperture. The end of the layer or carrier may have an elongated or flared end that is slightly larger than the aperture in the mat to prevent the carrier from being inadvertently pulled out of the aperture. In some configurations, a fastener may be provided to further attach or connect the layer or carrier to the suspension mat after the carrier is pulled through or received into the aperture to further secure the comfort system to the suspension system. However, in some configurations, it may be sufficient to rely only on pulling the carrier through or into the aperture to provide a quick and cost-efficient method of assembling or connecting the comfort system to the suspension system.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein may suitably be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may be or may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

### LISTING OF REFERENCE NUMERALS

10 vehicle
12 vehicle seat
13 frame
14 seating portion
16 backrest portion
18 cushion
20 cover or trim layer
22 seating portion frame
24 backrest portion frame
100 seat system (combined system)
102 seat suspension system
104 comfort system
106 thermal system
108 pneumatic system
110 suspension mat
112 suspension attaching members
114 orifice or pass through feature in the suspension mat 110
116 bag structure
118 top layer
120 bottom layer
122 air mover
124 one or more ventilation apertures in top layer 118
126 edges of top/bottom layer 118, 120
128 open space in bag structure 116
130 spacer layer
132 heating layer
134 connectors or connection methods
136 air cells
138 carrier or substrate supporting the one or more air cells 136
140 fluid source
142 tube

1. A combined comfort and suspension system for a vehicle seat comprising:
a suspension system; and
a comfort system;
wherein the comfort system is attached to the suspension system before the combined comfort and suspension system is installed in the vehicle seat.

2. The combined comfort and suspension system according to claim 1, wherein the comfort system comprises a thermal system, a pneumatic system, or both; and the suspension system comprises a suspension mat.

3. The combined comfort and suspension system according to claim 2, wherein the thermal system and/or the pneumatic system is connected to the suspension mat via one or more connectors or connection methods.

4. The combined comfort and suspension system according to claim 3, wherein the thermal system comprises a bag structure having a top layer and a bottom layer, and either the top layer or the bottom layer is connected to the suspension mat via the one or more connectors or connection methods.

5. The combined comfort and suspension system according to claim 3, wherein the thermal system comprises a bag structure that is connected to the suspension mat via the one or more connectors or connection methods, wherein the bag structure comprises a top layer and the suspension mat comprises a bottom layer of the bag structure.

6. The combined comfort and suspension system according to claim 3, wherein the thermal system comprises a bag structure that is connected to the suspension mat via the one or more connectors or connection methods, wherein the bag structure comprises a bottom layer and the suspension mat comprises a top layer of the bag structure.

7. The combined comfort and suspension system according to claim 5, wherein a spacer layer is provided within the bag structure.

8. The combined comfort and suspension system according to claim 6, wherein the suspension mat comprises one or more pass-through features that allow an air flow to pass between the suspension mat.

9. The combined comfort and suspension system according to claim 1, wherein the pneumatic system comprises a carrier that is connected to the bag structure via one or more connectors or connection methods.

10. The combined comfort and suspension system according to claim 1, wherein the pneumatic system comprises one or more bladders or air cells that are connected directly to the bag structure or the suspension mat via one or more connectors or connection methods.

11. The combined comfort and suspension system according to claim 1, further comprising a cushion.

12. A method of making the combined comfort and suspension system according to claim 1, wherein the method comprises attaching the comfort system to the suspension system before the combined comfort and suspension system is installed in or attached to the vehicle seat.

13. The method according to claim 12, wherein the method comprises attaching a layer of the thermal system to the suspension mat to form a bag structure into which an air flow is configured to pass, wherein the bag structure is defined between the layer and the suspension mat.

14. The method according to claim 12, wherein the method comprises attaching a layer of the thermal system to the suspension mat to form a bag structure into which an air flow is connected to pass, wherein the bag structure is defined between the layer and an opposing layer such that the suspension mat forms no part of the bag structure.

15. The method according to claim 12, wherein the method comprises attaching the pneumatic system to one or more layers of the bag structure and/or the suspension mat.

16. The method according to claim 15, wherein the pneumatic system comprises one or more air cells that are attached directly to the one or more layers of the bag structure and/or to the suspension system.

17. The method according to claim 15, wherein the pneumatic system comprises one or more air cells that are supported on a carrier, and the carrier is attached to the one or more layers of the bag structure and/or to the suspension system.

18. The method according to claim 15, wherein the method comprises attaching a seat cushion to the combined comfort and suspension system.

19. A vehicle seat comprising the combined comfort and suspension system according to claim 1.

20. A method of installing the combined comfort and suspension system according to claim 1 into a vehicle seat, wherein the method comprises attaching the combined comfort and suspension system to a frame of the vehicle seat.
